(19) United States
(12) Patent Application Publication
(10) Pub. No.: US 2022/0234353 A1
(43) Pub. Date: Jul. 28, 2022

(54) INKJET HEAD AND INKJET RECORDING DEVICE

(71) Applicant: Toshiba Tec Kabushiki Kaisha, Tokyo (JP)

(72) Inventor: Shota Ito, Mishima Shizuoka (JP)

(21) Appl. No.: 17/532,195

(22) Filed: Nov. 22, 2021

(30) Foreign Application Priority Data
Jan. 25, 2021 (JP) 2021-009664

(51) Int. Cl. B41J 2/045; B41J 2/16

(52) U.S. Cl. CPC B41J 2/04588; B41J 2/1623; B41J 2/04581; B41J 2/1646; B41J 2/04541

(57) ABSTRACT

An inkjet head includes an actuator that deforms in response to a drive signal from a drive circuit to change a volume of a pressure chamber to eject ink from a nozzle connected to the pressure chamber. The drive signal includes a main interval during which the ink is ejected and an auxiliary interval during which the ink is not ejected. The main interval includes a first pulse applying a first voltage, a first period maintaining the reference potential, and a second pulse applying a second voltage having a polarity opposite from the first voltage. The auxiliary interval is prior to the main interval and includes a third pulse applying a third voltage having the same polarity as the first voltage and a second period maintaining the reference potential.

### CROSS-REFERENCE TO RELATED APPLICATION

This application is based upon and claims the benefit of priority from Japanese Patent Application No. 2021-009664, filed Jan. 25, 2021, the entire contents of which are incorporated herein by reference.

### FIELD

Embodiments described herein generally relate to an inkjet head and an inkjet recording device.

### BACKGROUND

An inkjet head that uses an actuator as a partition wall of an ink pressure chamber is known. The actuator deforms according to an applied drive signal to change the volume of the pressure chamber, which causes a pressure vibration in the ink. Due to this pressure vibration, ink droplets are ejected from a nozzle connected to the pressure chamber.

In such an inkjet head, so-called satellite droplets may be separated from primary (or main) droplets in some cases and land on a medium (paper or the like). Also, in some cases, an ink mist, somewhat similar to satellite droplets but generally smaller in size may be generated when ink droplets are ejected from a nozzle. These satellite droplet and mist phenomena cause deterioration of inkjet print quality, so that it is desirable to suppress these phenomena.

To suppress such phenomena, a timing of the drive signal can possibly be adjusted. For example, it has been proposed to adjust a drive signal such that a plurality of ink droplets are ejected within the ejection cycle of what would nominal otherwise be one ink droplet and the multiple ink droplets are combined in the air before landing on a medium. However, if the timing of the drive signal is adjusted only in consideration of avoidance of satellite and mist phenomena, it is likely that optimum pressure vibration cannot be obtained and that ejection stability and print quality deteriorate.

Hence, there is a need for an inkjet head and an inkjet recording device capable of suppressing or mitigating ink droplet separation that causes satellite and mist phenomena while maintaining ink ejection stability for achieving higher-quality printing.

### BRIEF DESCRIPTION OF THE DRAWINGS

FIG. 1 depicts a configuration example of an inkjet recording device according to an embodiment.

FIG. 2 depicts a configuration example of an inkjet head in a perspective view according to an embodiment.

FIG. 3 depicts a configuration example of a head body of an inkjet head in an exploded perspective view according to an embodiment.

FIG. 4 depicts a partial configuration example of an inkjet head in a cross-sectional view according to an embodiment.

FIG. 5 is a block diagram of a configuration example of a control system of an inkjet recording device according to an embodiment.

FIG. 6 shows an example of states of a pressure chamber of an inkjet head according to an embodiment.

FIG. 7 shows an example of a pressure fluctuation simulation result of a medium-viscosity ink using a drive signal in related art.

FIG. 8 shows an example of a pressure fluctuation simulation result of a low-viscosity ink using a drive signal in related art.

FIG. 9 shows an example of a waveform of a drive signal used in an inkjet head according to an embodiment.

FIG. 10 shows an example of a flying state of ink droplets when a drive signal in related art is used.

FIG. 11 shows an example of a flying state of ink droplets when a drive signal according to an embodiment is used.

FIG. 12 shows an example of a dot separation suppressing effect due to a pulse width of an auxiliary pulse according to an embodiment.

FIG. 13 shows an example of a measurement result of a dot-to-dot distance according to a pulse width of an auxiliary pulse according to an embodiment.

FIG. 14 shows an example of a dot separation suppressing effect due to a pulse width of a contraction pulse according to an embodiment.

FIG. 15 shows an example of a measurement result of a dot-to-dot distance according to a pulse width of a contraction pulse according to an embodiment.

### DETAILED DESCRIPTION

According to one or more embodiments, an inkjet head includes an actuator and a drive circuit. The actuator deforms in response to a drive signal and changes a volume of a pressure chamber connected to a nozzle so as to eject ink contained in the pressure chamber from the nozzle. The drive circuit applies the drive signal to the actuator. The drive signal includes a main interval during which the ink is ejected from the nozzle and an auxiliary interval during which the ink is not ejected from the nozzle. The main interval includes a first pulse by which a first voltage is applied to the actuator, a first period in which the actuator is maintained at a reference potential, and a second pulse by which a second voltage having a polarity opposite to that of the first voltage is applied to the actuator. The auxiliary interval is prior to the main interval and includes a third pulse in which a third voltage having the same polarity as the first voltage is applied to the actuator and a second period in which the actuator is maintained at the reference potential.

Hereinafter, certain example embodiments will be described with reference to the accompanying drawings. The same or substantially similar elements, components, and the like will be denoted by the same reference numerals and duplicate description may be omitted for subsequent instances. If a plurality of the same or substantially similar elements are depicted, a common reference numeral may be used to describe each element in the plurality.

An inkjet recording device according to an embodiment forms an image on a medium, such as paper, by using an inkjet head. For example, the inkjet recording device ejects ink from a pressure chamber included in the inkjet head as ink droplets to form an image on a medium. Examples of the inkjet recording device include, but are not limited to, an office inkjet recording device, a barcode inkjet recording device, a Point-Of-Sale (POS) inkjet recording device, an industrial inkjet recording device, a 3D inkjet recording device, and the like. A medium on which the inkjet recording device forms an image is not limited to a specific configuration.

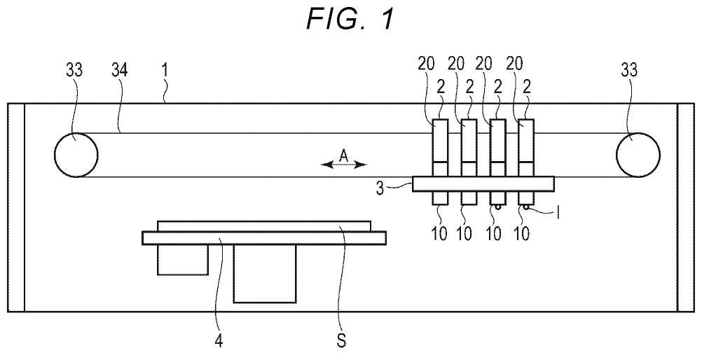

As illustrated in FIG. 1, the inkjet recording device 1 according to the present embodiment forms an image on an image forming medium S or the like by using a recording material such as ink. As an example, the inkjet recording device 1 includes a plurality of ink ejection units 2, a head support mechanism 3, and a medium support mechanism (or a support unit) 4. The head support mechanism 3 movably supports the ink ejection units 2. The support mechanism 4 movably supports the image forming medium S. The image forming medium S is, for example, a sheet made of paper, cloth, resin, or the like.

The ink ejection units 2 are supported by the head support mechanism 3 in parallel in a predetermined direction. The head support mechanism 3 is attached to an endless belt 34 hung on rollers 33. By rotating the rollers 33, the inkjet recording device 1 moves the head support mechanism 3 in a main scanning direction A intersecting a conveyance direction of the image forming medium S. Each ink ejection unit 2 integrally includes an inkjet head 10 and a circulation device 20. The ink ejection unit 2 performs an operation of ejecting ink I from the inkjet head 10. The inkjet recording device 1 uses, for example, a scanning method in which an image is formed on an image forming media S by performing the ink ejection operation while reciprocating the head support mechanism 3 in the main scanning direction A. Alternatively, the inkjet recording device 1 may be configured as a single-pass system in which the ink ejection operation is performed without moving the head support mechanism 3. In the latter case, it is not necessary to provide the roller 33 and the endless belt 34. In this case, the head support mechanism 3 can be fixed to, for example, a housing or the like of the inkjet recording device 1.

The ink ejection units 2 respectively eject, for example, four different color inks corresponding to CMYK (cyan, magenta, yellow, and key/black), that is, cyan ink, magenta ink, yellow ink, and black ink.

The inkjet head 10 according to the present embodiment is of a shear-mode shared wall type and a circulation type having a side shooter design. The inkjet heads 10 may be of another type in other embodiments.

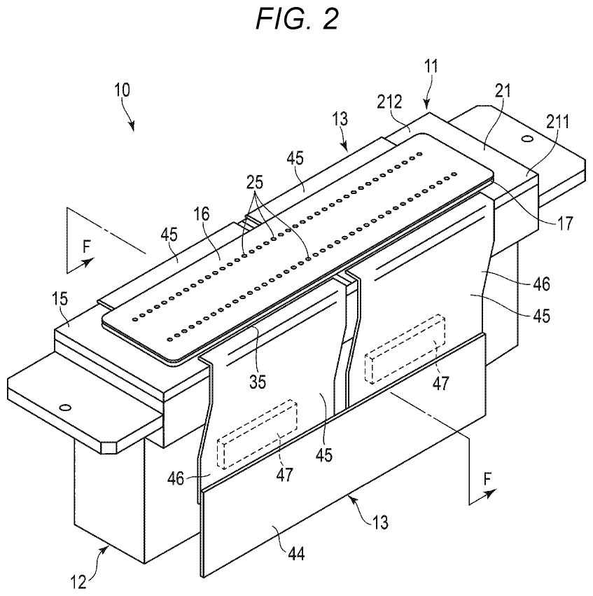

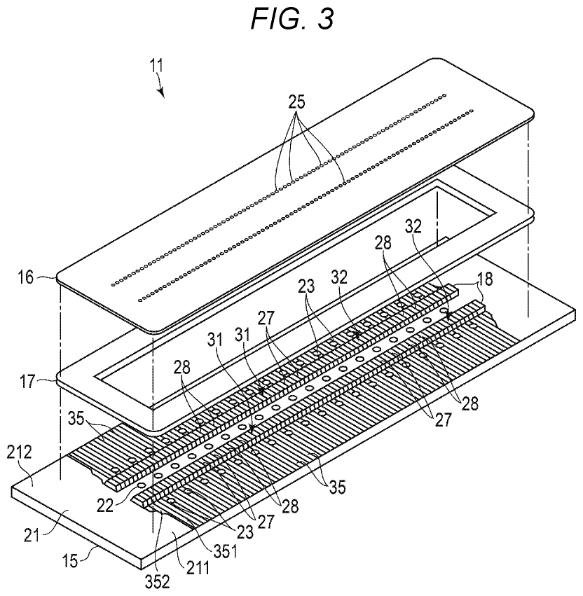

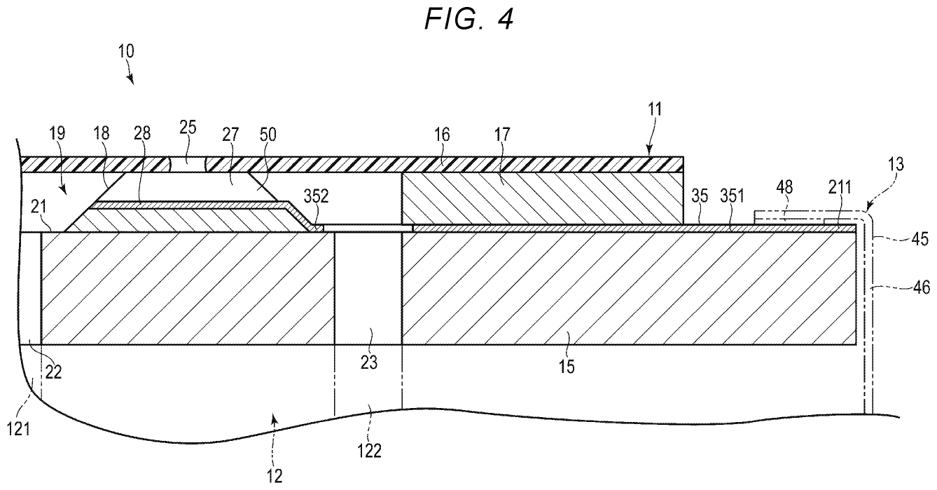

FIG. 2 is a perspective view illustrating an example of the configuration of the inkjet head 10. FIG. 3 is an exploded perspective view illustrating an example of the configuration of the inkjet head 10. FIG. 4 is a cross-sectional view taken along the line F-F of FIG. 2.

As illustrated in FIG. 2, the inkjet head 10 is mounted on the inkjet recording device 1 and is connected to an ink tank via a component, such as a tube. The inkjet head 10 includes a head body 11, a unit portion 12, and a pair of circuit boards 13.

The head body 11 is a device for ejecting ink. The head body 11 is attached to the unit portion 12. The unit portion 12 includes: a manifold that forms part of a path between the head body 11 and the ink tank; and a member for mounting inside the inkjet recording device 1. The pair of circuit boards 13 are attached to the head body 11.

As further illustrated in FIGS. 3 and 4, the head body 11 includes a base plate 15, a nozzle plate 16, a frame member 17, and a pair of drive elements 18. As illustrated in FIG. 4 in a cross-sectional view taken along the line F-F of FIG. 2, an ink chamber 19 to which ink is supplied is formed inside the head body 11.

As illustrated in FIG. 3, the base plate 15 has a rectangular plate shape made of ceramics, such as alumina. The base plate 15 has a flat mounting (or installation) surface 21. The base plate 15 has a plurality of supply holes 22 and a plurality of discharge holes 23 open on the mounting surface 21.

The supply holes 22 are provided in the longitudinal direction of the base plate 15 at the central portion of the base plate 15. Each supply hole 22 communicates with an ink supply unit 121 of the manifold of the unit portion 12. The supply hole 22 is connected to the ink tank in the circulation device 20 via the ink supply unit 121. The ink in the ink tank is supplied to the ink chamber 19 through the ink supply unit 121 and the supply hole 22.

The discharge holes 23 are provided in two rows interposing the supply hole 22 therebetween. Each discharge hole 23 communicates with an ink discharge unit 122 of the manifold of the unit portion 12. The discharge hole 23 is connected to the ink tank in the circulation device 20 via the ink discharge unit 122. The ink in the ink chamber 19 is collected in the ink tank through the ink discharge unit 122 and the discharge hole 23. In this manner, the ink circulates between the ink tank and the ink chamber 19.

The nozzle plate 16 is formed of, for example, a rectangular shaped film made of polyimide having a liquid-repellent function on the surface. The nozzle plate 16 faces the mounting surface 21 of the base plate 15. The nozzle plate 16 is provided with a plurality of nozzles 25. The plurality of nozzles 25 are aligned in two rows along the longitudinal direction of the nozzle plate 16.

The frame member 17 is formed of, for example, a nickel alloy in a rectangular frame shape. The frame member 17 is interposed between the mounting surface 21 of the base plate 15 and the nozzle plate 16. The frame member 17 is adhered to the mounting surface 21 and the nozzle plate 16. The nozzle plate 16 is attached to the base plate 15 with the frame member 17 interposed therebetween. As illustrated in FIG. 4, the ink chamber 19 is surrounded by the base plate 15, the nozzle plate 16, and the frame member 17.

Each drive element 18 comprises, for example, two plate-shaped piezoelectric bodies formed of lead zirconate titanate (PZT). The two piezoelectric bodies are bonded together so that the polarization directions are opposite to each other in the thickness direction.

The pair of drive elements 18 are adhered to the mounting surface 21 of the base plate 15. The pair of drive elements 18 are arranged in parallel in the ink chamber 19 corresponding to the nozzles 25 arranged in two rows. The drive element 18 is formed in a trapezoidal cross section. The top of the drive element 18 is adhered to the nozzle plate 16.

The drive element 18 is provided with a plurality of grooves 27. The grooves 27 extend in a direction intersecting the longitudinal direction of the drive element 18, and the grooves are aligned in the longitudinal direction of the drive element 18. The plurality of grooves 27 face the plurality of nozzles 25 of the nozzle plate 16. The drive element 18 of the present embodiment has a plurality of pressure chambers 50 each filled with ink, which are arranged in the groove 27.

Electrodes 28 are provided in the plurality of grooves 27, respectively. Each electrode 28 is formed, for example, by photoresist patterning and etching process on a nickel thin film. The electrode 28 covers an inner surface of the groove 27.

A plurality of wiring patterns 35 are provided on the base plate 15, extending from the mounting surface 21 to and over the drive element 18. The wiring patterns 35 are formed, for example, by photoresist patterning and etching on a nickel thin film.

The wiring patterns 35 exist on both sides of the longitudinal row of the supply holes 22 at positions corresponding to the pair of the drive elements 18 and extend from one side-end portion 211 and another side-end portion 212 of the mounting surface 21 in the width direction of the base plate 15. Each of the side-end portions 211 and 212 includes not only an edge of the mounting surface 21 but also a peripheral region of the edge. Therefore, the wiring patterns 35 may extend from either the edge or the edge peripheral region of the mounting surface 21.

The wiring pattern 35 that extends from the side-end portion 211 is shown in FIG. 4. The configuration of the wiring pattern 35 of the other side-end portion 212 is the same or substantially the same as that of the wiring pattern 35 of the side end portion 211.

The wiring line pattern 35 has a first portion 351 and a second portion 352. The first portion 351 extends in a linear shape from the side end portion 211 of the mounting surface 21 toward the drive element 18. The neighboring first portions 351 extend parallel to each other (see FIG. 3). The second portion 352 extends from one end portion of the first portion 351 to and over the electrode 28. The second portion 352 is electrically connected to the electrode 28.

For the drive element 18, there are electrodes 28 among the plurality of electrodes 28 designated as a first electrode group 31 and other electrodes 28 among the plurality of electrodes 28 are designated as a second electrode group 32.

The first electrode group 31 and the second electrode group 32 are separated from each other by a central portion of the drive element 18 in the longitudinal direction. That is the central portion of the drive element 18 can be considered as a border dividing the first electrode group 31 from the second electrode group 32. The second electrode group 32 is adjacent to the first electrode group 31 across the central portion of the drive element 18. Each of the first and second electrode groups 31 and 32 includes, for example, one-hundred and fifty-nine (159) electrodes 28. The number of the electrodes 28 is not limited thereto.

Referring back to FIG. 2, each of the circuit boards 13 has a board body 44 and a pair of film carrier packages (FCP) 45. The FCP can also be referred to as a tape carrier package (TCP) in some instances.

The board body 44 is a rigid printed wiring board (printed circuit board) formed in a rectangular shape. Various electronic components and connectors can be mounted on the board body 44. The pair of FCPs 45 are attached to the board body 44.

Each of the FCPs 45 has a resin film 46 on which a plurality of wirings are formed. The resin film 46 has flexibility. Each FCP 45 also has a head drive circuit 47 connected to the plurality of wirings. The film 46 is a tape automated bonding (TAB) element or the like. The head drive circuit 47 is an integrated circuit (IC) for applying voltages to the electrodes 28. The head drive circuit 47 is fixed to the film 46 by a resin.

One end portion of the FCP 45 is thermocompression bonded to the first portion 351 of the wiring pattern 35 by an anisotropic conductive film (ACF) 48. By doing so, the plurality of wirings of the FCP 45 are electrically connected to the wiring patterns 35.

By connecting the FCP 45 to the wiring patterns 35, the head drive circuit 47 is electrically connected to the electrodes 28 via the wirings of the FCP 45. The head drive circuit 47 applies a voltage to the electrodes 28 via the wirings of the film 46.

The voltage application deforms each of the drive elements 18 in shear mode such that the volume of each of the pressure chambers 50 in which the electrode 28 is provided increases or decreases. By doing so, the pressure of the ink in the pressure chamber 50 changes, and the ink is ejected from the nozzle 25. In this manner, the drive element 18 that separates the pressure chamber 50 serves as an actuator for applying the pressure vibration to the inside of the pressure chamber 50.

The circulation device 20 illustrated in FIG. 1 is integrally connected to an upper portion of the inkjet head 10 by a connecting component made of a metal or the like. The circulation device 20 includes a predetermined circulation path configured to allow ink to circulate through the ink tank and the inkjet head 10. The circulation device 20 includes a pump for circulating the ink. The ink is supplied from the circulation device 20 into the inkjet head 10 through the ink supply unit 121 by an action of the pump, passes through a predetermined flow path, and then is sent from the inside of the inkjet head 10 to the circulation device 20 through the ink discharge unit 122.

Further, the circulation device 20 supplies the ink to the circulation path from a cartridge provided as a supply tank outside the circulation path.

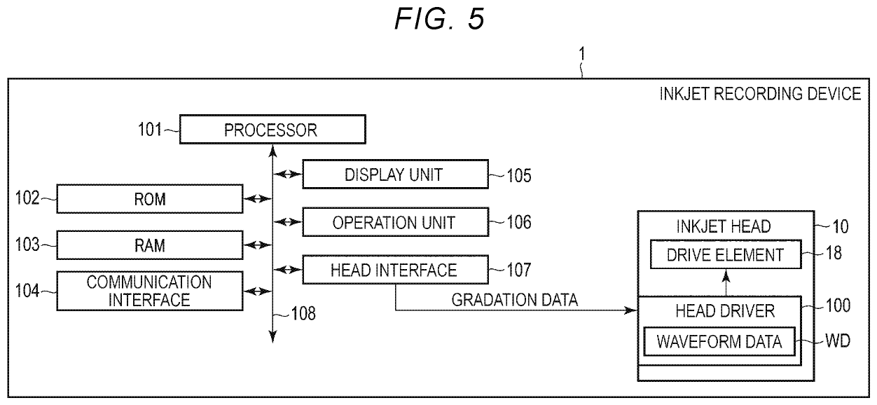

An example of a circuit configuration of the inkjet recording device 1 according to the present embodiment is illustrated in FIG. 5.

The inkjet recording device 1 includes a processor 101, a ROM 102, a RAM 103, a communication interface 104, a display unit 105, an operation unit 106, a head interface 107, a bus 108, and the inkjet head 10.

The processor 101 corresponds to a central portion of a computer that performs processes and control required for operation of the inkjet recording device 1. The processor 101 controls each unit to realize various functions of the inkjet recording device 1 based on a program or programs, such as system software, application software, or firmware, stored in the ROM 102. The processor 101 is, for example, a central processing unit (CPU), a micro processing unit (MPU), a system on a chip (SoC), a digital signal processor (DSP), a graphics processing unit (GPU), or the like. Alternatively, the processor 101 is a combination of these components.

The ROM 102 is a non-volatile memory used exclusively for reading data, which corresponds to a main memory portion of the computer in which the processor 101 is used as a central portion. The ROM 102 stores the program. The ROM 102 also stores data or various set values used by the processor 101 to perform various processes.

The RAM 103 is a memory used for reading and writing data, which corresponds to a main memory portion of the computer in which the processor 101 is used as a central portion. The RAM 103 is used as a so-called work area or the like for temporarily storing data used by the processor 101 to perform various processes.

The communication interface 104 is for the inkjet recording device 1 to communicate with a host computer or the like via a network or a communication cable.

The display unit 105 displays a screen for notifying an operator of the inkjet recording device 1 of various pieces of information. The display unit 105 is, for example, a display such as a liquid crystal display or an organic electro-luminescence (EL) display.

The operation unit 106 accepts an input operation by an operator of the inkjet recording device 1. The operation unit 106 is, for example, a keyboard, a keypad, a touch pad, a mouse, or the like. Furthermore, as the operation unit 106, a touch pad superimposed on the display panel of the display unit 105 can also be used. The display panel provided on a touch panel can be used as the display unit 105, and the touch pad provided on the touch panel can be used as the operation unit 106.

The head interface 107 is provided for the processor 101 to communicate with the inkjet head 10. The head interface 107 transmits gradation data and the like to the inkjet head 10 under the control of the processor 101.

The bus 108 includes a control bus, an address bus, a data bus, and the like and transmits signals to and from each unit of the inkjet recording device 1.

The inkjet head 10 includes a head driver 100 as a control unit.

The head driver 100 is a drive circuit for operating the inkjet head 10. The head driver 100 includes the head drive circuit 47 and the like. The head driver 100 is, for example, a line driver. The head driver 100 stores one or more waveform data WD.

The head driver 100 repeatedly generates a single drive signal based on the waveform data WD. Then, the head driver 100 controls the number of times of ejecting ink to each pixel on the image forming medium S based on the gradation data transmitted from the head interface 107. Each time the single drive signal is generated and applied to the drive element 18, one ink droplet (that is one main drop) is ejected from the nozzle 25 of the inkjet head 10. Therefore, the inkjet recording device 1 expresses shading depending on, for example, how many drops of ink are ejected to each pixel. The more sets of ink are ejected to one pixel, the darker the shade of the corresponding color in the pixel becomes.

In one instance, the head driver 100 is provided to an administrator, a user, or the like of the head driver 100 with the waveform data WD stored therein. In another instance, the head driver 100 may be provided to an administrator, a user, or the like without the waveform data WD stored therein. In still another instance, the head driver 100 may be provided to an administrator, a user, or the like with other waveform data are stored. The appropriate waveform data WD may be separately provided to an administrator, a user, or the like and written to the head driver 100 under operation by the administrator, the user, or the like or by a service person or the like. The provision of the waveform data WD may be realized, for example, by recording of data on a non-transitory removable storage medium, such as a magnetic disk, a magneto-optical disk, an optical disk, or a semiconductor memory, or by downloading via a network or the like.

Upon the application of the drive signal, the drive element 18 (which is a piezoelectric body) deforms in shear mode. Due to this deformation, the volume of the pressure chamber 50 changes.

In this example, it is assumed that the pressure chamber 50 will be in a normal (e.g., not contracted and not expanded) state when the drive signal is not being applied or otherwise the present potential value of the drive signal is 0 V. If the potential of the drive signal is positive, the pressure chamber 50 contracts, and the volume of the pressure chamber 50 decreases as compared with the normal state. If the potential of the drive signal is negative, the pressure chamber 50 expands, and the volume of the pressure chamber 50 increases as compared with the normal state. As the volume of the pressure chamber 50 changes, the pressure on the ink in the pressure chamber 50 changes. The inkjet head 10 ejects ink upon application of a drive signal having a specific waveform.

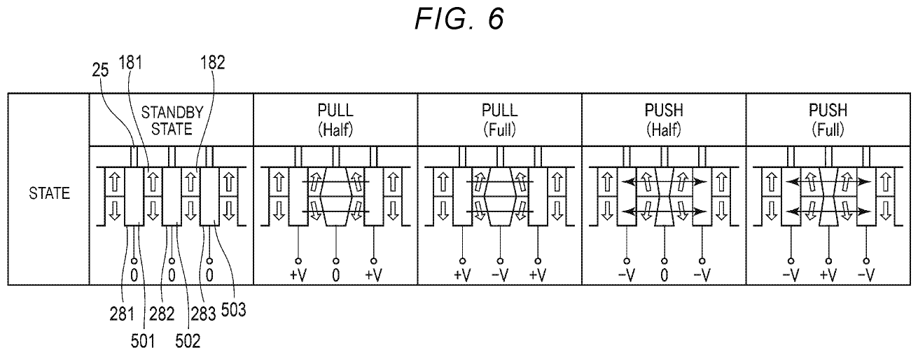

As shown in FIG. 6, a pressure chamber 502 that is the same or substantially the same as the pressure chamber 50 of the inkjet head 10 according to the present embodiment changes to a standby state, a “PULL (Half)” state, a “PULL (Full”) state, a “PUSH (Half)” state, and a “PUSH (Full)” state.

In the standby state, the pressure chamber 502 is in a normal state. As illustrated in FIG. 6, the head driver 100 sets all potentials of an electrode 282 formed in the pressure chamber 502 and electrodes 281 and 283 formed in pressure chambers 501 and 503 on both sides adjacent to the pressure chamber 502 to a reference potential of 0 V (or ground potential GND). The chambers 501 and 503 are the same or substantially the same as the pressure chamber 50, and the electrodes 281, 282, 283 are the same or substantially the same as the electrode 28 in the present embodiment. In this standby state, a drive element 181 interposed between the pressure chamber 501 and the pressure chamber 502 and a drive element 182 interposed between the pressure chamber 502 and the pressure chamber 503 do not cause any distortion. The drive elements 181 and 182 are the same or substantially the same as the drive element 18 in the present embodiment.

In the PULL (Half) state, the pressure chamber 502 expands. The head driver 100 sets the electrode 282 of the pressure chamber 502 to a potential of 0 V and applies a voltage of +V to the electrodes 281 and 283 of the pressure chambers 501 and 503. In this state, an electric field of voltage value of 1V acts on each of the drive elements 181 and 182 in a direction intersecting the polarization direction of the drive element 18. By this action, each of the drive elements 181 and 182 deforms outward to expand the pressure chamber 502.

In the PULL (Full) state, the pressure chamber 502 expands more than PULL (Half). The head driver 100 applies a negative voltage of “−V” to the electrodes 282 of the pressure chamber 502 and applies a voltage of “+V” to the electrodes 281 and 283 of the pressure chambers 501 and 503. In this state, an electric field having a voltage value of 2 V acts on each of the drive elements 181 and 182 in a direction intersecting the polarization direction of the drive element 18. By this action, each of the drive elements 181 and 182 deforms outward to further expand the pressure chamber 502 than PULL (Half).

In the PUSH (Half) state, the pressure chamber 502 contracts. The head driver 100 sets the electrode 282 of the pressure chamber 502 to a potential of 0 V and applies a voltage of “−V” to the electrodes 281 and 283 of the pressure chambers 501 and 503. In this state, an electric field of the voltage value 1 V acts on each of the drive elements 181 and 182 in a direction opposite to the drive voltage of PULL (Half) or PULL (Full). By this action, each of the drive elements 181 and 182 deforms inward to contract the pressure chamber 502.

In the PUSH (Full) state, the pressure chamber 502 contracts more than PUSH (Half). As The head driver 100 applies a voltage of “+V” to the electrodes 282 of the pressure chamber 502 and applies a voltage of “−V” to the electrodes 281 and 283 of the pressure chambers 501 and 503. In this state, an electric field having a voltage value of 2 V acts on each of the drive elements 181 and 182 in a direction opposite to the drive voltage of PULL (Half) or PULL (Full). By this action, each of the drive elements 181 and 182 deforms inward to further contract the pressure chamber 502 than PUSH (Half).

When the volume of the pressure chamber 502 expands or contracts, pressure vibration (oscillation) occurs in the pressure chamber 502. Due to this pressure vibration, the pressure in the pressure chamber 502 increases and the ink droplets are ejected from the nozzle 25 that communicates with the pressure chamber 502.

In this manner, the drive elements 181 and 182 that separate the pressure chambers 501, 502, and 503 from each other serve as actuators for applying the pressure vibration to the inside of the pressure chamber 502 that has the drive elements 181 and 182 as wall surfaces. That is, the pressure chamber 50 expands or contracts according to the operation of the drive element 18.

Each pressure chamber 50 shares the drive element 18 (as a partition wall) with an adjacent pressure chamber 50. For this reason, the head driver 100 cannot drive each pressure chamber 50 individually. As one example, the present embodiment applies three-division driving in which the head driver 100 divides pressure chambers 50 into three driving sets of every two chambers and drives the heads accordingly. Embodiments of the disclosure are not limited thereto. Four-division driving, five-division driving, or the like may be used.

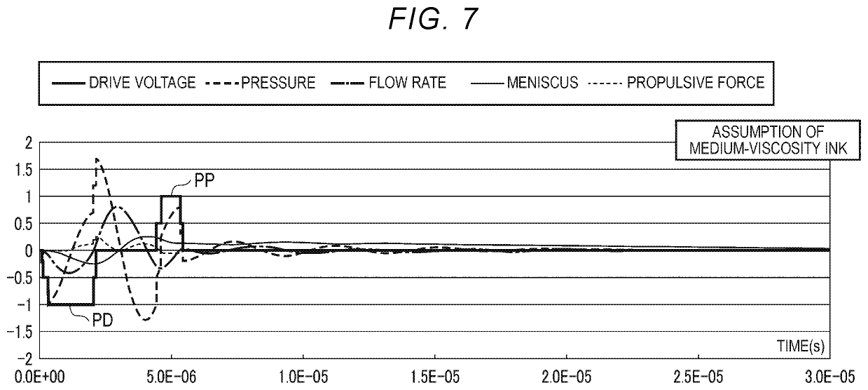

An example of a pressure fluctuation simulation result of a medium-viscosity ink using a drive signal in the related art is shown in FIG. 7. Herein, a medium-viscosity ink refers to an ink of 5 centipoise (cps) or more. The simulation was performed by using an LCR equivalent circuit (not separately illustrated) that simulates an inkjet head. In FIG. 7, the horizontal axis represents time. The thick solid line “drive voltage” is a waveform representing a voltage change of the drive signal. The drive signal includes a pulse PD and a pulse PP. The pulse PD is a waveform representing application of a negative voltage (−1.0 V) from the reference potential of 0 V to expand the pressure chamber 50 and subsequent application of 0V to contract the pressure chamber 50 to the normal state. In the pulse PD, due to the expansion of the pressure chamber 50 by the application of the negative voltage (−1.0 V) and the subsequent contract of the pressure chamber 50 back to the normal state by the application of the reference potential 0 V, the pressure in the pressure chamber 50 rises so that ink droplets are ejected from the nozzle 25. The pulse PP is a waveform applied after the pulse PD. The pulse PP is a waveform representing application of a positive voltage (+1.0 V) from the reference potential of 0 V to contract the pressure chamber 50 and subsequent application of 0 V to expand the pressure chamber 50 back to the normal state. The pulse PP is applied after a certain period of time has elapsed after the application of the pulse PD. The coarse broken line “pressure” in FIG. 7 is a waveform representing a change in the pressure on the ink in the vicinity of the nozzle 25. The one-dot dashed line “flow rate” in FIG. 7 is a waveform representing a change in the flow rate of the ink flowing into the nozzle 25. The thin solid line “meniscus” in FIG. 7 is a waveform representing a change in the shape of the liquid surface of the ink at the nozzle 25. The change in the meniscus corresponds to the change in the volume of ink in the vicinity of the nozzle. The fine broken line “propulsive force” in FIG. 7 is a waveform representing a change in the force pushing out the ink. The propulsive force is proportional to both pressure and meniscus. In the interval between the pulse PD and the pulse PP, the potential of the drive signal is maintained at 0 V, but the pressure still fluctuates during this interval, and the flow rate, the meniscus, and the propulsive force also fluctuate greatly. After the pulse PP, the potential of the drive signal is maintained at 0 V again, but residual vibration still occurs in the pressure, the flow rate, the meniscus, and the propulsive force.

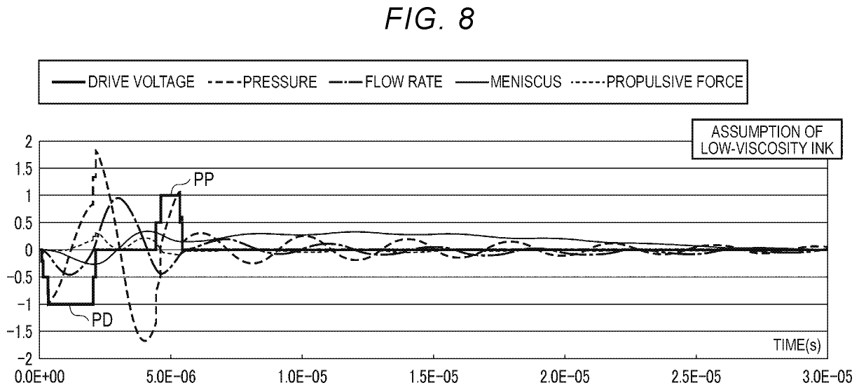

An example of a pressure fluctuation simulation result of a low-viscosity ink using the same drive signal as that used for the simulation result in FIG. 7 is shown in FIG. 8. Herein, a low-viscosity ink refers to an ink of less than 5 cps. Each waveform in FIG. 8 corresponds to each waveform described with respect to FIG. 7.

In comparison with FIGS. 7 and 8, ejection of the low-viscosity ink causes much more residual vibration with respect to the pressure, the flow rate, the meniscus, and the propulsive force after the pulse PP than the ejection of the medium-viscosity ink. Such residual vibration results in dot separation and dispersal during the ink ejection and deteriorates print quality. With the drive signal in the related art, while the residual vibration can be suppressed or mitigated to some extent in the case of the medium-viscosity, the residual vibration cannot be suppressed if low-viscosity ink is used, and the print quality will be deteriorated. For this reason, the medium-viscosity ink is generally recommended for high quality printing in the related art.

In the inkjet head 10, when a single ink droplet is ejected the ejected ink droplet may become separated during flight. This phenomenon is called dot separation. The separation of the ink droplet can occur in various shapes, but generally separation produces a main drop, a forward drop, and a backward drop occurs. For convenience of description, “main drop” is considered to refer to the largest of the ink droplets formed during flight. The “forward drop” is considered to refer to an ink droplet separated to the image forming medium S side from the main drop. The “backward drop” is considered to refer to an ink droplet separated to the nozzle side from the main drop. Separated drops may land at different positions on the image forming medium S when either the inkjet head 10 or the image forming medium S move during ejections, and if the degree of separation is large, the print quality can be deteriorated. In this context, “dispersal” refers to an erroneous ejection in which the main drop does not eject in the first place or the main drop does not form from the ejected ink. The lower the viscosity of the ink, the more likely dot separation and dispersal will occur. In general, it is expected that printing quality can be improved by suppressing dot separation and dispersal.

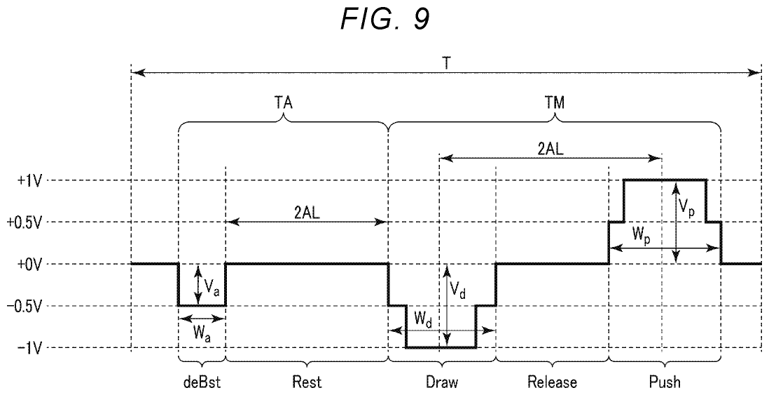

FIG. 9 depicts an example of a waveform of a drive signal used in the inkjet head 10 according to an embodiment. For the simplicity of description, it will be assumed that the inkjet head 10 operates in a single drop mode by which one printed dot is to be formed on a medium using one ink droplet, and thus a drive signal of a cycle of ejecting one ink droplet (referred to as “single cycle”) will be described. The head driver 100 ejects a predetermined amount of ink droplets from the nozzle 25 every cycle by applying the drive signal illustrated in FIG. 9 to the drive element 18.

In the example, the drive signal includes an auxiliary interval TA and a main interval TM within each cycle T. The main interval TM is an interval during which ink droplets are ejected from the nozzle 25. The main interval TM includes an expansion pulse (“Draw”), a retention period (“Release”), and a contraction pulse (“Push”).

The expansion pulse (Draw) is a first type pulse in the main interval TM and applies a first voltage V_{d} to the drive element 18. In the example, the first voltage V_{d} is a negative voltage (for example, −1.0V). When the expansion pulse (Draw) is applied, the drive element 18 deforms in shear mode to expand the volume of the pressure chamber 50.

In the example, the pulse width W_{d} of the expansion pulse (Draw) corresponds to the time width starting from the reference potential of 0 V, passing through −0.5 V, reaching −1.0 V, passing through −0.5 V again, and returning to the reference potential of 0 V. The pulse width W_{d} of the expansion pulse (Draw) is, for example, 1.52 μs. The time when the voltage is maintained at an intermediate voltage (−0.5 V) during the falling edge and the rising edge of the pulse is about 0.2 μs. The application of the intermediate voltage is provided by taking into consideration the power efficiency, but such a stepwise pulse is not necessarily used in the present embodiment. Once the expansion pulse (Draw) returns to 0 V, the pressure in the pressure chamber 50 rises, and the ink is ejected from the nozzle 25. The expansion pulse (Draw) is also called the ejection pulse.

The retention period (Release) is a period after the expansion pulse (Draw) during which the drive element 18 is maintained at the reference potential (for example, 0 V) that does not cause deformation of the drive element 18. Similarly to those illustrated in FIGS. 7 and 8, pressure fluctuations (oscillations) occur during the retention period (Release).

The contraction pulse (Push) is a second type pulse in the main interval TM and is after the retention period (Release). The contraction pulse (PUSH) applies a second voltage Vₚ having a polarity opposite to that of the first voltage V_{d} to the drive element 18. In the example, the second voltage Vₚ is a positive voltage (for example, +1.0V). When the contraction pulse (Push) is applied, the drive element 18 deforms in shear mode to contract the volume of the pressure chamber 50. The contraction pulse (Push) is also called a cancel pulse and dampens or offsets the pressure vibration occurring by the expansion pulse (Draw).

In the example, the pulse width Wₚ of the contraction pulse (Push) corresponds to the time width starting from the reference potential of 0 V, passing through +0.5 V, reaching +1.0 V, passing through +0.5 V again, and returning to the reference potential of 0 V. Half the time of the natural vibration cycle 2AL of the pressure chamber 50 is defined as one AL (acoustic length). The pulse width Wₚ of the contraction pulse (Push) has a maximum time width of about one AL. The pulse width Wₚ is, for example, 1.20 μs. The time when the voltage is maintained at +0.5 V during the rising edge and the falling edge of the pulse is about 0.2 μs. The stepwise pulse takes power efficiency into consideration but is not necessarily used in the present embodiment.

The length of the retention period (Release) is set so that the distance between the center of the pulse width W_{d} of the expansion pulse (Draw) and the center of the pulse width Wₚ of the contraction pulse (Push) is maintained to be 2AL. That is, the length of the retention period (Release) is equal to the natural vibration cycle (2AL) of the pressure chamber 50 (more particularly, the pressure chamber 50 with an ink/liquid therein). The length of the retention period (Release) is determined after the pulse width Wₚ of the contraction pulse (Push) is set. The length of the retention period (Release) is, for example, 1.68 μs. In this example, the natural vibration cycle (2AL) 3.04 μs.

The auxiliary interval TA is provided in each cycle T before the main interval TM within the same cycle T. The auxiliary interval TA is an interval during which ink droplets are not ejected from the nozzle 25. The auxiliary interval TA includes an auxiliary pulse (“deBst”) and a rest period (Rest).

The auxiliary pulse (deBst) is a third type pulse within the cycle T, and a third voltage Vₐ having the same polarity as the first voltage V_{d} of the expansion pulse (Draw) is applied to the drive element 18. In the example, the amplitude of the auxiliary pulse (that is a voltage applied by the auxiliary pulse) is one-half (½) of the amplitude of the expansion pulse (that is a voltage applied by the expansion pulse (Draw)). For example, the voltage applied by the auxiliary pulse is −0.5 V. The pulse width Wₐ of the auxiliary pulse (deBst) has a time width of AL×⅓ at the maximum. That is, the pulse width Wₐ of the auxiliary pulse (deBst) is one-sixth (⅙) or less of the natural vibration cycle of the pressure chamber 50. The pulse width Wₐ of the auxiliary pulse (deBst) is, for example, 0.5 μs.

The rest period (Rest) maintains the drive element 18 at the reference potential after the auxiliary pulse (deBst). The rest period (Rest) is held for a length of 2AL. That is, the length of the rest period (Rest) is equal to the natural vibration cycle of the pressure chamber 50.

In the auxiliary interval TA, the auxiliary pulse (deBst) expands the pressure chamber 50 by applying a negative voltage to the drive element 18. That is, the head driver 100 changes the pressure chamber 50 from the standby state to a PULL (Half) state. When the pressure chamber 50 expands, the pressure in the pressure chamber 50 decreases, and as a result, ink will be filled into the pressure chamber 50 from the common ink chamber 5. During the rest period (Rest), by keeping drive element 18 at the reference potential, the pressure chamber 50 returns from the PULL (Half) to the standby state. When the pressure chamber 50 returns to the standby state, the pressure chamber 50 contracts from the previously expanded state, and the pressure in the pressure chamber 50 rises, but this pressure change is set so as not to eject the ink droplets from the nozzle. That is, in the auxiliary interval TA, the pressure chamber 50 expands and relaxes, but ink droplets are not ejected.

Then, in the main interval TM, the expansion pulse (Draw) causes the pressure chamber 50 to re-expand by applying a negative voltage to the drive element 18 again. That is, the head driver 100 changes the state of the pressure chamber 50 from the standby state to the PULL (Full) state (though passing through PULL (Half) state as an intermediate state). Thus, the pressure chamber 50 expands again, and the pressure in the pressure chamber 50 decreases. Since the expansion pulse (Draw) utilizes a voltage twice that of the auxiliary pulse (deBst), the pressure chamber 50 is expanded further than with application of the auxiliary pulse (deBst).

During the retention period (Release), by maintaining the drive element 18 at the reference potential, the pressure chamber 50 returns again to the standby state (via PULL (Half)state). Since the voltage change applied to the drive element 18 is greater than the voltage change in the auxiliary interval TA, greater pressure change occurs in the ink contained in the pressure chamber 50.

The contraction pulse (Push) contracts the pressure chamber 50 by applying a positive voltage to the drive element 18. That is, the head driver 100 changes the state of the pressure chamber 50 from the standby state to the PUSH (Full) state (via PUSH (Half)).

Accordingly, in the main interval TM, the pressure chamber 50 expands, relaxes, contracts, and relaxes in sequence. In this process, as the pressure in the pressure chamber 50 rises, the speed of the meniscus in the nozzle 25 exceeds a threshold value for ejecting ink droplets. When the speed of the meniscus exceeds the ejection threshold value, ink droplets are ejected from the nozzle 25 connected to the pressure chamber 50.

The specific voltage values illustrated in FIG. 9 represent only one example, and other values may be used. Similarly, each time length described in the disclosure is only one example and may be appropriately determined according to specific operating conditions, usage environment, structural parameters, and the like to be utilized.

According to the present embodiment, by providing the auxiliary interval TA prior to or in front of the main interval TM and expanding the pressure chamber 50 without ejecting ink, the residual pressure vibration caused by the previous cycle can be more effectively suppressed. By doing so, stable ink ejection can be performed after suppression of the previously induced vibration, and print quality can be improved. Furthermore, changing the pulse width Wₐ of the auxiliary pulse (deBst) changes the degree of separation of the forward drop, and changing the pulse width Wₚ of the contraction pulse (Push) changes the degree of separation of the backward drop. Therefore, the print quality can be further improved by selecting the appropriate values of the pulse widths Wₐ and Wₚ according to the usage environment, structural parameters, operating conditions, or the like.

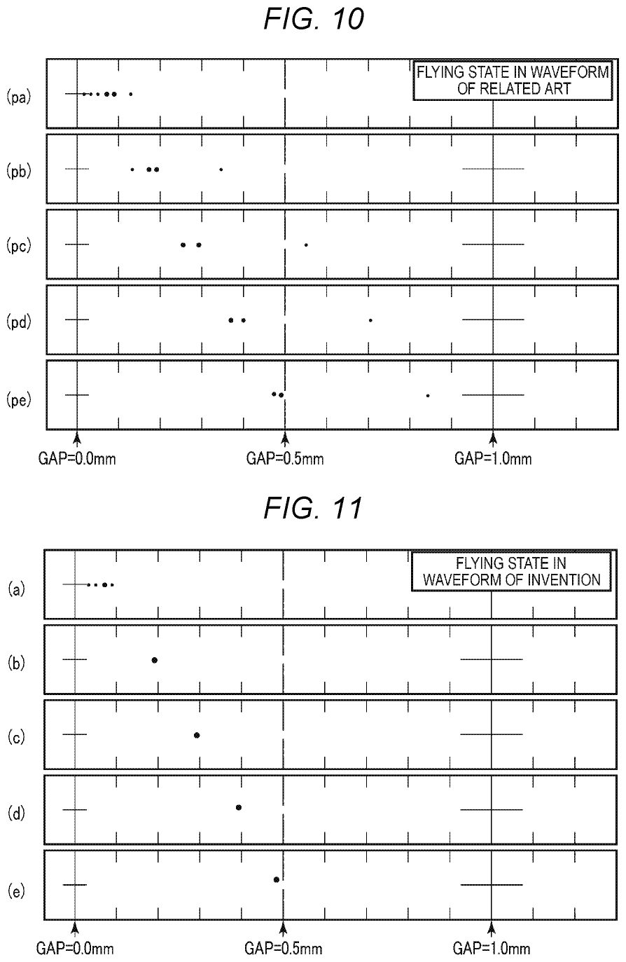

FIG. 10 is an example of a flying state of ink droplets when the drive signal of the related art (as illustrated in FIG. 7) is used. In FIG. 10, the horizontal axis represents the distance (GAP) from nozzle surface (GAP=0.0 mm, 0.5 mm, and 1.0 mm are specifically labeled), flight time (time) increases from the uppermost stage (pa) downward through to the stages (pb), (pc), (pd) and (pe). In the example, the ink droplets are dot-separated immediately after ejection (stage (pa)), and the degree of separation (that is the distance between the ink droplets) increases as time elapses and the distance from the nozzle surface increases.

FIG. 11 is an example of a flying state of ink droplets when the drive signal illustrated in FIG. 9 is used. In FIG. 11, the same conditions as those in FIG. 10 are used except the drive signal is different. In FIG. 11, the horizontal axis again represents the distance from the nozzle surface, and flight time increases from the uppermost stage (a) downward through the stages (b), (c), (d) and (e). In the example, the ink droplets are dot-separated immediately after ejection (stage (a)), but it is observed that the ink droplets initially separated during the flying are subsequently combined into one droplet, and thus, substantially no droplet separation is observed in stages (b) to (e).

An example of determining the optimum value of the pulse width in the inkjet head 10 according to the present embodiment will be described.

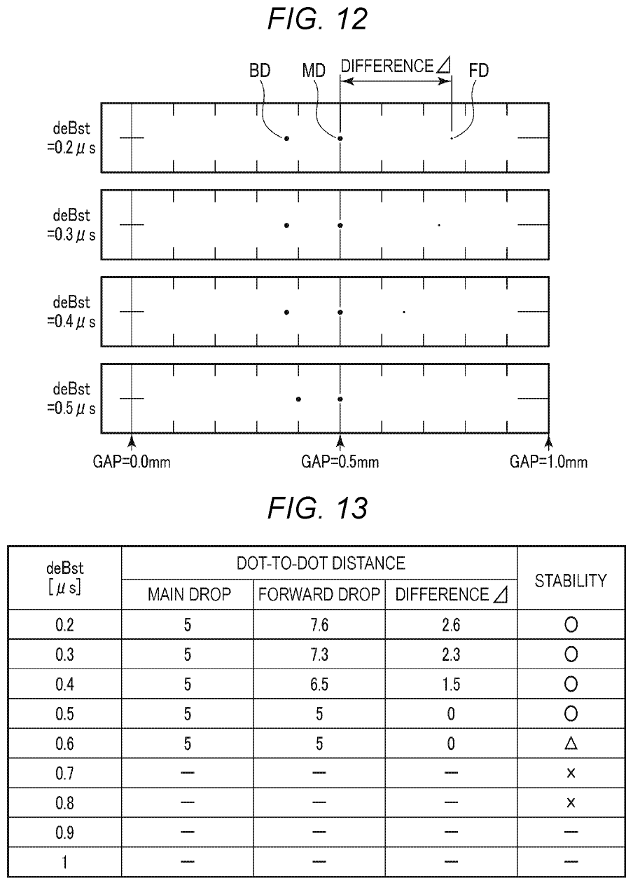

First, an example of determining the optimum value with respect to the pulse width Wₐ of the auxiliary pulse (deBst) will be described with reference to FIGS. 12 and 13.

FIG. 12 shows the dot separation suppressing effect due to the pulse width Wₐ of the auxiliary pulse (deBst). In the test, the value of the pulse width Wₐ (deBst) of the drive signal of FIG. 9 was set to various values as shown in FIG. 12 (deBst=0.2 μs, 0.3 μs, 0.4 μs, and 0.5 μs), and ink was ejected from the nozzle 25 of the inkjet head 10 at each setting. The conditions/settings other than the pulse width Wₐ were kept constant. The flying state of the ink was imaged at a position of GAP=0.5 mm from the nozzle, and the evaluation was performed by measuring the distance between the main drop MD and the forward drop FD.

Separation between the main drop MD and the forward drop FD was observed at deBst=0.2 μs, but substantially no separation was observed at deBst=0.5 μs. The backward drop BD did not change much even as the deBst value was changed.

FIG. 13 shows the measurement results of dot-to-dot distance according to changes in the pulse width Wₐ of the auxiliary pulse (deBst). The numerical values in the “dot-to-dot distance” sub-columns correspond to respective drop positions on the distance scale as indicated in FIG. 12, with the position value “5” in FIG. 13 for the main drop column indicating GAP=0.5 mm. The distance value (difference Δ) “2.6” between the main drop value and the forward drop value indicates Δ=2.6×10⁻¹ mm. The “stability” column entry is a three-stage evaluation based on a visual determination. “Stability=◯” denotes that there is no erroneous ejection such as bending or dispersal. “Stability=x” denotes that there is erroneous ejection such as bending or dispersal. “Stability=Δ” denotes marginal case between no erroneous ejection and erroneous ejection.

At pulse width Wₐ=0.2 μs, difference Δ=2.6×10⁻¹ mm. When pulse width Wₐ was increased, Δ became smaller, and when pulse width Wₐ=0.5 μs, Δ=0. At pulse width Wₐ=0.6 μs, no separation of the forward drop was observed, but the stability was reduced. Therefore, in this example, an optimum pulse width Wₐ=0.5 μs for the auxiliary pulse (deBst) was obtained.

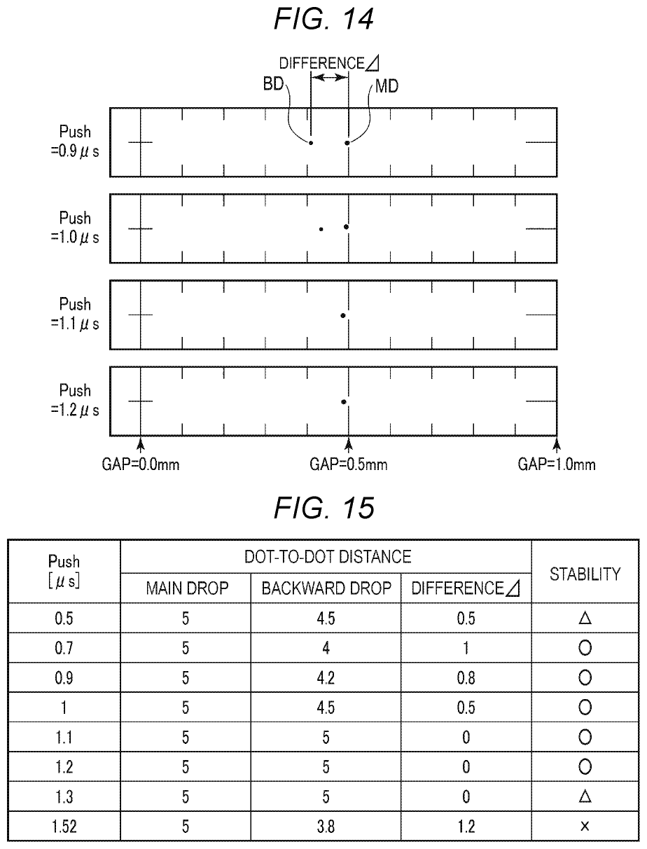

Next, an example of determining the optimum value for the pulse width Wₚ of the contraction pulse (Push) will be described with reference to FIGS. 14 and 15.

FIG. 14 shows one example of the dot separation suppressing effect due to the pulse width Wₚ of the contraction pulse (Push). In the test, the pulse width Wₚ (Push) of the drive signal of FIG. 9 was set to different values as shown in FIG. 14 (Push=0.9 μs, 1.0 μs, 1.1 μs, and 1.2 μs), and ink was ejected from the nozzle 25 of the inkjet head 10. The conditions other than the pulse width Wₚ were kept be constant. Similarly to FIG. 12, the flying state of the ink was imaged at a position of a distance GAP=0.5 mm from the nozzle, and an evaluation was performed by measuring the distance between the main drop MD and the backward drop BD (rather than the forward drop FD in FIG. 12).

Separation between the main drop MD and the backward drop BD was observed at Push=0.9 μs, but almost no separation was observed at Push=1.1 μs.

FIG. 15 shows the measurement results for the dot-to-dot distance for different values of the pulse width Wₚ of the contraction pulse (Push). Similarly to FIG. 13, the numerical value in the “dot-to-dot distance” column corresponds to the scale position in FIG. 14, and the listed position value “5” of the main drop indicates GAP=0.5 mm. Therefore, the distance (difference Δ) “0.5” between the main drop and the backward drop indicates Δ=0.5×10⁻¹ mm. The “stability” is again a three-stage evaluation by visual determination performed in a similar manner that described with respect to FIG. 13.

At pulse width Wₚ=0.5 μs, A=0.5×10⁻¹ mm. At pulse width Wₚ=0.7 μs, the difference spreads to A=1×10⁻¹ mm, but at pulse width Wₚ=1.1 μs and pulse width Wₚ=1.2 μs, A=0 was obtained. When pulse width Wₚ was further increased, the stability decreased at pulse width Wₚ=1.3 μs, and a phenomenon similar to dispersal occurred and the difference Δ expanded at pulse width Wₚ=1.52 μs. Therefore, in this example, the optimum pulse width Wₚ=1.1 μs or 1.2 μs for the contraction pulse (Push) was obtained.

In this manner, the separation of the forward drop can be suppressed by providing an auxiliary pulse (deBst) that reduces the pressure vibration and the Rest period that pauses fora certain period of time prior to the expansion pulse (Draw). Furthermore, the separation of the backward drop can be suppressed by a contraction pulse (Push) that reduces the pressure vibration generated by the expansion pulse (Draw). By appropriately selecting the pulse widths of both the auxiliary pulse (deBst) and the contraction pulse (Push), the dot separation suppressing effect can be further improved. Such a separation suppressing effect can also be obtained even if a low-viscosity ink (less than 5 cps) is used.

The inkjet head 10 and the inkjet recording device 1 provided with the inkjet head 10 according to the present embodiment can realize the ejection of ink droplets without dot separation by applying a drive signal as described above to the drive element 18 (an actuator). Accordingly, it is possible to provide an inkjet head 10 and an inkjet recording device 1 capable of effectively suppressing the dot separation and dispersal of ink while maintaining ejection stability and performing high-quality printing.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An inkjet head, comprising:
an actuator configured to deform in response to a drive signal to change a volume of a pressure chamber connected to a nozzle and eject ink from the pressure chamber through the nozzle; and
a drive circuit configured to apply the drive signal to the actuator, the drive signal having:
a main interval during which the ink is ejected from the nozzle, the main interval including a first pulse during which a first voltage is applied to the actuator, a first period during which the actuator is maintained at a reference potential, and a second pulse during which a second voltage with a polarity opposite to the first voltage is applied to the actuator, and
an auxiliary interval during which the ink is not ejected from the nozzle, the auxiliary interval being prior to the main interval and including a third pulse during which a third voltage of the same polarity as the first voltage is applied to the actuator and a second period during which the actuator is maintained at the reference potential.

2. The inkjet head according to claim 1, wherein the third voltage has an amplitude value that is one-half an amplitude value of the first voltage.

3. The inkjet head according to claim 1, wherein the time between the center of a pulse width of the first pulse and the center of a pulse width of the second pulse is equal to a natural vibration cycle of ink in the pressure chamber.

4. The inkjet head according to claim 3, wherein the pulse width of the second pulse is one-half or less of the natural vibration cycle.

5. The inkjet head according to claim 1, wherein a pulse width of the third pulse is one-sixth or less of a natural vibration cycle of ink in the pressure chamber.

6. The inkjet head according to claim 5, wherein the second period is equal to the natural vibration cycle.

7. The inkjet head according to claim 1, wherein during the auxiliary period, the pressure chamber expands due to the third pulse.

8. The inkjet head according to claim 7, wherein during the main period, the pressure chamber expands due to the first pulse and contracts due to the second pulse.

9. The inkjet head according to claim 1, wherein the application of the first voltage is greater than the third voltage.

10. The inkjet head according to claim 1, wherein the actuator comprises a piezoelectric body.

11. A liquid ejection head, comprising:
a pressure chamber in fluid communication with a nozzle;
an actuator configured to receive a drive signal and change a volume of the pressure chamber in response to the drive signal; and
a drive circuit configured to supply the drive signal to the actuator, the drive signal comprising:
a main interval during which the liquid is ejected from the nozzle, the main interval including a first pulse during which a first voltage is applied to the actuator, a first period during which the actuator is maintained at a reference potential, and a second pulse during which a second voltage with a polarity opposite to the first voltage is applied to the actuator, and
an auxiliary interval during which the liquid is not ejected from the nozzle, the auxiliary interval being prior to the main interval and including a third pulse during which a third voltage of the same polarity as the first voltage is applied to the actuator and a second period during which the actuator is maintained at the reference potential.

12. The liquid ejection head according to claim 11, wherein the third voltage has an amplitude value that is one-half an amplitude value of the first voltage.

13. The liquid ejection head according to claim 11, wherein the time between the center of a pulse width of the first pulse and the center of a pulse width of the second pulse is equal to a natural vibration cycle of the liquid in the pressure chamber.

14. An inkjet device, comprising:
an inkjet head configured to eject ink towards a recording medium and comprising:
an actuator configured to deform in response to a drive signal and change a volume of a pressure chamber that communicates with a nozzle to eject ink in the pressure chamber from the nozzle; and
a drive circuit configured to apply the drive signal to the actuator, the drive signal comprising:
a main interval during which the ink is ejected from the nozzle, the main interval including:
a first pulse in which a first voltage is applied to the actuator;
a first period in which the actuator is maintained at a reference potential; and
a second pulse in which a second voltage having a polarity opposite to the first voltage is applied to the actuator; and
an auxiliary interval during which the ink is not ejected from the nozzle, the auxiliary interval being prior to the main interval and including:
a third pulse in which a third voltage having the same polarity as the first voltage is applied to the actuator; and
a second period during which the actuator is maintained at the reference potential.

15. The inkjet device according to claim 14, wherein the third voltage has an amplitude value of ½ an amplitude value of the first voltage.

16. The inkjet device according to claim 14, wherein a time between a first center of a first pulse width of the first pulse and a second center of a second pulse width of the second pulse is equal to a natural vibration cycle of the ink in the pressure chamber.

17. The inkjet device according to claim 16, wherein the second pulse width is ½ or less of the natural vibration cycle.

18. The inkjet device according to claim 14, wherein a third pulse width of the third pulse is ⅙ or less of a natural vibration cycle of ink in the pressure chamber.

19. The inkjet device according to claim 18, wherein a length of the second period matches the natural vibration cycle.

20. The inkjet device according to claim 14, wherein the application of the first pulse during the main period expands the pressure chamber by an amount that is greater than the expansion of the pressure chamber by the third pulse during the auxiliary period.
